(19) United States
(12) Patent Application Publication
(10) Pub. No.: US 2009/0284983 A1
(43) Pub. Date: Nov. 19, 2009

(54) INTRINSICALLY-SAFE SYSTEM FOR MINESHAFT ILLUMINATION

(76) Inventor: Bart Levine, Mountain Lakes, NJ (US)

Correspondence Address: Elizabeth Herbst Schierman;Dykas, Shaver & Nipper, LLP, PO Box 877, Boise, ID, 83701, US

(21) Appl. No.: 12/122,427

(22) Filed: May 16, 2008

(51) Int. Cl. G02B 6/04

(52) U.S. Cl. 362/554

(57) ABSTRACT

Disclosed is an intrinsically-safe system for mineshaft illumination. The system includes a main optical fiber bundle that receives light from a light source at one end and disperses the light into a mineshaft or tunnel through diffusers attached to the other end of the fibers. The light from the light source is first passed through a non-imaging optical tube, so as to evenly distribute the light, and then through a tapering bundle of optical fibers that focus the light into the entry end of the main optical fiber bundle. Accordingly, light is distributed to the mineshaft without the risk of potential explosion of accumulated gases that may be present in the mineshaft.

### FIELD OF THE INVENTION

The invention generally relates to a system for safe operation in the deep-rock mining industry and more particularly to a system for safely illuminating tunnels or shafts.

### BACKGROUND OF THE INVENTION

In a mine shaft, the need for illumination systems is inevitable, as is the unwanted accumulation of naturally-occurring flammable gases. When such gas accumulations reach potentially-explosive concentrations, there is a potential for a large loss of life should those gases be ignited. This potential is an ever-present concern when using conventional lighting systems to illuminate the mineshafts and tunnels. These conventional lighting systems, including incandescent, fluorescent, gas discharge, electrical arc, and combustion technologies, all make use of material that is energize sufficiently so as to be capable of igniting accumulations of explosive gases.

Managing the threat of explosion is usually accomplished through the use of ventilation means so as to combat the accumulation of the gases, gas detection means so as to determine when gas accumulations reach dangerous levels, and ignition-suppression procedures so as to prevent ignition of the gases as by electrical lighting systems.

Ignition-suppression procedures are generally either isolative or intrinsic approaches. With isolative approaches, the goal is to isolate the threat of ignition, such as by placing more of a boundary between the potential igniter and the gas. For example, armoring conventional lamp fixtures helps to manage the risk that the lamp fixture could ignite accumulated gases. However, armoring lamp fixtures is expensive and only partially reduces the risk because the potential igniter is still in the vicinity of the potentially-explosive gases. With intrinsic approaches, on the other hand, the goal is to remove the threat of ignition altogether by creating an intrinsically-safe environment, an environment in which the gas will not come into contact with the potential igniter. Because intrinsic ignition-suppression approaches eliminate the threat of ignition completely, these approaches are more desirable, but often more complex and expensive.

Light emitting diodes operate at colder-than-ignition temperatures and are generally well encapsulated in plastic. Accordingly, light emitting diodes are a promising technology for the mine safety industry. However, presently, the amount of white light required in the mining tunnels and other mining workplaces cannot be easily met with the use of light emitting diodes. Further, the electrical circuits necessary to power light emitting diodes continues to present an ignition hazard when illuminating spaces potentially containing explosive gas accumulations. After all, it could be generally said that the entire electrical distribution, connection, and conversion circuit of a mine's lighting system is a potential ignition source and therefore a hazard. Managing the risk requires that the entire system be addressed, but even addressing the entire system is still only management of the risk, not an intrinsically-safe system.

One intrinsically-safe approach to mine shaft lighting systems is to locate the light source and all electrical circuits therefor outside of the mine explosion hazard area and to then distribute the light through the tunnels and shafts through a light guide such as an optical fiber. An optical fiber is, generally, a glass or plastic fiber that acts as a waveguide as it carries light along its length. The fiber comprises a core and a cladding layer. As it travels along the fiber, light is kept within the fiber due to internal reflection of the light.

The amount of light energy that is required for adequate illumination of the interior space of a mine shaft or tunnel is in the range of many thousands of lumens. To transport this scale of light, an optical fiber needs a significant physical core space, which is quite different than the space needed by fibers designed for communications, which requires precise, intermittent light transports measured on the individual photon level. Thus, fibers with large core diameters, preferably greater than 100 microns, are more suitable for transporting light for illuminating spaces.

Large core fibers made of plastic may be inexpensively constructed; however, the inherent attenuations of plastic fibers limit effective lengths to fewer than one hundred meters. Thus, using plastic fiber for remote illumination of mine shafts and tunnels will generally be ineffective. Glass fiber, on the other hand, is well suited to systems in which the carried light is to be transported long distances. However, glass fiber is generally considered uneconomical in that it is more costly, heavier, and less flexible than plastic fiber. In order to utilize a glass fiber to transfer light for remote illumination, the correct selection of cladding materials, sufficient source-light intensity, and efficient coupling of segments of fibers is required.

A 200 micron diameter core Borosilicate glass fiber clad according to U.S. Pat. No. 6,463,200, issued Oct. 8, 2002, to Yoel Fink et al. is capable of transporting practical amounts of visible light energy over the extensive distances expected in mine shaft and tunnel installations. The cladding described in the '200 patent is that of multiple microscopic layers of tellurium alternated with polystyrene.

### SUMMARY OF THE INVENTION

Embodiments of the present system provide an intrinsically-safe system for illuminating a mineshaft or tunnel. More particularly, this system utilizes large-diameter optical fibers to remotely transport light from a light source to an area to be illuminated. It utilizes a bundle of glass fibers cladded with a special refractive cladding, such as those described in the '200 patent, where each fiber is configured to provide a visible spectrum radiant flux that approaches the fiber's full modal carrying capacity. This is accomplished by effectively overfilling the fiber launch at the source light and efficiently coupling the light source to the main fiber bundle using a tapered fused optical fiber bundle.

To minimize cost, the size and intensity of the light source is maximized while the number of light sources is minimized. Further the light source used is configured to project a large amount of visible light on a relatively small spot size so as to allow for the most efficient coupling of the light source to the main fibers. Preferably, the light source includes a properly collimated sulfur plasma light source that is located in an area free of potentially-explosive gases. Also included is a reflector configured for direction the radiated light energy given off by the plasma chamber of the light source toward the main fiber bundle.

Because it is expected that the spot size of the light source will exceed the entry area of the fiber bundle, a fiber optic light guide is placed between the source light and the fiber bundle's entry end so as to funnel the light from the light source to the entry end of the fibers in the main bundle. This light guide is preferably a portion of bundled tapered optical fibers. In other embodiments, the light guide may be a tapered cladded rod. Each of the output ends of the tapered fibers are fused to an entry end of the fibers of the main fiber bundle.

The cladding on the fibers of the tapering portion is preferably a conventional cladding, which is more heat tolerant than the cladding on the fibers of the main fiber bundles. In this way, the cladding of the tapering portion is better suited to handle the heat generated by the light source, particularly heat due to transference of infrared light. Accordingly, the cladding of the tapering section is configured to absorb infrared light naturally. In some embodiments, the tapering section may be cooled externally so as to discourage transfer of heat from the tapered section to the main fiber bundle.

A non-imaging optical tube is placed between the light source and the tapering portion so as to evenly distribute the light energy from the light source on the tapering portion and to maximize the power output to the tapering portion. Thus, each entry end of the fibers in the tapered portion will receive a more nearly equal amount of light energy from the light source. The dimensions of the non-imaging optical tube are configured to accommodate uniformity of the flux of light energy from the light source to the tapering section.

Diffusers are attached to the terminating ends of the fibers of the main fiber bundle. The diffusers act to scatter the transmitted light so that it best radiates throughout the space to be illuminated. Preferably, the diffuser is an acrylic rod with a frosted surface. The rod is fitted with a hole into which the terminating end of at least one of the fibers in the main fiber bundle is inserted and adhered thereto. Such diffusers may be attached to various fibers' terminating ends and may be attached along various locations of the length of the main fiber bundle.

Accordingly, the present system provides a purely-optical system for distributing light to a mineshaft or tunnel, a system that requires no electrical cords within the shaft. Thus, it is an intrinsically-safe illumination system. Further, it offers a relatively simple lighting system that requires little maintenance, has great reliability and serviceability, and a lower cost of operation than the traditional ignition-safe lighting systems. Additionally, much of the heat given off by the system is isolated to source-light part of the system, which reduces the heat added into the mineshaft and tunnels themselves.

The purpose of the foregoing summary is to enable the public and especially the scientists, engineers, and practitioners in the art who are not familiar with patent or legal terms or phraseology, to determine quickly from a cursory inspection, the nature and essence of the technical disclosure of the application. The summary is neither intended to define the invention of the application, which is measured by the claims, nor is it intended to be limiting as to the scope of the invention in any way.

Still other features and advantages of the present system will become readily apparent to those skilled in this art from the following detailed description describing preferred embodiments of the system, simply by way of illustration of the best mode contemplated by carrying out this system. As will be realized, the system is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is an isometric, perspective, exploded view of a first embodiment of the intrinsically-safe system for mineshaft illumination.

FIG. 2 is an isometric, perspective, exploded view of a portion of the intrinsically-safe system for mineshaft illumination according to the first embodiment.

### DESCRIPTION OF THE PREFERRED EMBODIMENTS

While the system is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

In the following description and in the figures, like elements are identified with like reference numerals. The use of “or” indicates a non-exclusive alternative without limitation unless otherwise noted. The use of “including” means “including, but not limited to,” unless otherwise noted.

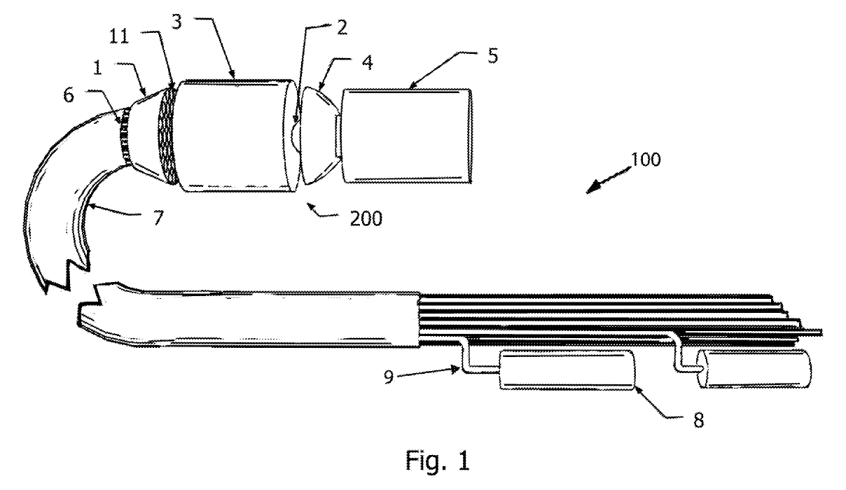

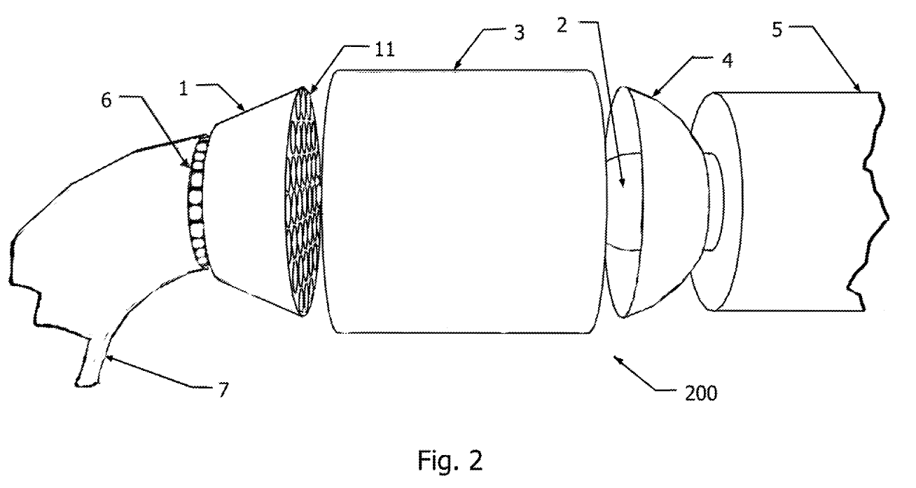

As shown in FIGS. 1 and 2 and for purpose of illustration, the intrinsically-safe system for mineshaft illumination is embodied in a fiber optic lighting system 100 that includes a light source subsystem 200. It is preferred that the light source subsystem 200 comprise a sulfur plasma lamp 5 to which is attached a parabolic reflector 4 configured to encourage transmission of light energy from a rotating plasma chamber 2 away from the sulfur plasma lamp 5 toward a first end of a non-imaging tube 3. Such a light source subsystem 200 is capable of projecting a reflected 400,000 lumens of largely-useful light on a relatively small spot size of 50 mm. In other embodiments, the light source includes a metal halide discharge lamp.

The non-imaging tube 3 is configured to transfer light energy from the light source subsystem 200 toward a first end of a tapered fused optical fiber bundle 1 with essentially a uniform distribution of the flux of light to the first end of the tapered fused optical fiber bundle 1.

The tapered fused optical fiber bundle 1 comprises a bundle of optical fibers that taper from the first end of each, i.e., the end near the light source subsystem 200, toward a second end that is fused to the entry end 6 of the main optical fiber bundle 7. The tapered fused optical fiber bundle 1 is configured to essentially effectively overfill the entry end 6 of the main optical fiber bundle 7 with light received from the light source subsystem 200. Ideally, the number of fibers in the tapered fused optical fiber bundle 1 is minimized so as to just fully accept the light energy from the light source system 200.

In some embodiments the optical fibers of the tapered fused optical fiber bundle 1 comprises optical fibers having a conventional optical fiber cladding that is more heat tolerant than the special cladding included on the fibers of the main optical fiber bundle 7. In addition, some embodiments may include a mechanism for cooling the tapered fused optical fiber bundle 1 so as to discourage transfer of heat received by the tapered optical fiber bundle 1 from the light source subsystem 200 to the main optical fiber bundle 7.

The main optical fiber bundle 7 is situated so as to carry light from the entry end 6 to the exit end 9 of each fiber of the main optical fiber bundle 7. The fibers of the main optical fiber bundle 7 are configured to transport a visible spectrum radiant flux that approaches the fiber's full modal carrying capacity. Preferably, the exit ends 9 are located within a mineshaft or mine tunnel desired to be illuminated. Adhered to at least one of the exit ends 9 is a light diffuser 8. Preferably, one light diffuser 8 is adhered to each of the exit ends 9 of the fibers of the main optical fiber bundle 7. According to the first embodiment shown in FIG. 1, the light diffusers 8 are acrylic rods into which exit ends 9 have been inserted. The acrylic rods have frosted surfaces configured to accommodate scattering of the light received at the exiting end 9 that is transferred into the light diffuser 8. Preferably, each of a plurality of exit ends 9 located at various places along the length of the main fiber optical bundle 7 will have adhered to each a light diffuser 8. Thus, spaces along various sections of the length of the main optical fiber bundle 7 may be illuminated by either a single light diffuser 8 or a plurality of light diffusers 8. Ideally, the surface area of each diffuser is minimized.

According to the preferred embodiment shown in FIGS. 1 and 2, the main optical fiber bundle 7 comprises 200 micron diameter core Borosilicate glass fiber with a special refractive cladding, preferably a cladding comprising multiple microscopic layers of tellurium alternated with polystyrene, such as that described in U.S. Pat. No. 6,463,200.

The exemplary embodiment shown in the figures and described above illustrates but does not limit the invention. It should be understood that there is no intention to limit the invention to the specific form disclosed; rather, the invention is to cover all modifications, alternative constructions, and equivalents falling within the spirit and scope of the invention as defined in the claims. For example, while the exemplary embodiments illustrate the use of sulfur plasma as the light source, a metal Halide discharge lamp could be made to function similarly. Further, while a tapered fiber concentrator device is preferably employed to couple the fibers, various concentrator designs could be substituted. Additionally, the fiber end diffuser illuminator could be configured with numerous different geometries. Further, while the invention is not limited to use in mining tunnels, it is expected that various embodiments of the system will be particularly useful in such locations. Hence, the foregoing description should not be construed to limit the scope of the invention, which is defined in the following claims. Accordingly, while there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. An intrinsically-safe system for mineshaft illumination comprising:
a main optical fiber bundle comprising a plurality of main optical fibers, each of said main optical fibers having an entry end and an exiting end, said main optical fiber bundle having a main bundle entry end comprising said entry ends of said main optical fibers, and said main optical fiber bundle having a main bundle exiting end comprising said exiting ends of said main optical fibers;
a tapered optical fiber bundle comprising a plurality of tapering optical fibers fixedly attached to one another, each of said tapering optical fibers having a wide entry end and a narrow exiting end, said tapered optical fiber bundle having a tapered bundle wide entry end comprising said wide entry ends of said tapering optical fibers, and said tapered optical fiber bundle having a tapered bundle narrow exiting end comprising said narrow exiting ends of said tapering optical fibers, said tapered bundle narrow exiting end being attached to said main bundle entry end;
a non-imaging optical tube having a non-imaging tube entry end and a non-imaging tube exiting end, said non-imaging tube exiting end being attached to said tapered bundle wide entry end;
an illumination source configured to project light toward said non-imaging tube entry end; and
at least one diffuser attached to at least one main optical fiber's exiting end, each of said diffusers being configured to scatter light received by said diffuser to said mineshaft so as to illuminate said mineshaft;
wherein said light projected by said illumination source travels through non-imaging tube and is, thereby and thereafter essentially evenly distributed on said tapered bundle wide entry end; and
wherein said light travels through said tapering optical fibers, into said main optical fiber bundle, along said main optical fibers, and into said diffusers.

2. The intrinsically-safe system for mineshaft illumination of claim 1, wherein said main optical fibers have a cladding comprising a plurality of microscopic layers of tellurium alternated with layers of polystyrene.

3. The intrinsically-safe system for mineshaft illumination of claim 1, wherein said illumination source comprises a sulfur plasma lamp connected to a parabolic reflector configured to focus light energy emitted from a plasma chamber.

4. The intrinsically-safe system for mineshaft illumination of claim 1, wherein each of said diffusers comprises an acrylic rod having a frosted surface.

5. An intrinsically-safe system for mineshaft illumination comprising:
a main optical fiber bundle comprising a plurality of main optical fibers, each of said main optical fibers having an entry end and an exiting end, said main optical fiber bundle having a main bundle entry end comprising said entry ends of said main optical fibers, and said main optical fiber bundle having a main bundle exiting end comprising said exiting end comprising said exiting ends of said main optical fibers;
a tapered optical fiber bundle comprising a plurality of tapering optical fibers fixedly attached to one another, each of said tapering optical fibers having a wide entry end and a narrow exiting end, said tapered optical fiber bundle having a tapered bundle wide entry end comprising said wide entry ends of said tapering optical fibers, and said tapered optical fiber bundle having a tapered bundle narrow exiting end comprising said narrow exiting ends of said tapering optical fibers, said tapered bundle narrow exiting end being attached to said main bundle entry end;
a non-imaging optical tube having a non-imaging tube entry end and a non-imaging tube exiting end, said non-imaging tube exiting end being attached to said tapered bundle wide entry end;
an illumination source configured to project light toward said non-imaging tube entry end; and
a plurality of diffusers each attached to at least one main optical fiber's exiting end, each of said diffusers being configured to scatter light received by said diffuser to said mineshaft so as to illuminate said mineshaft;
wherein said light projected by said illumination source travels through non-imaging tube and is, thereby and thereafter essentially evenly distributed on said tapered bundle wide entry end; and
wherein said light travels through said tapering optical fibers, into said main optical fiber bundle, along said main optical fibers, and into said diffusers.

6. The intrinsically-safe system for mineshaft illumination of claim 5, wherein said diffusers are located at various points along said main optical fiber bundle.

7. An intrinsically-safe system for mineshaft illumination comprising:
a main optical fiber bundle comprising a plurality of 200 micron diameter borosilicate glass fibers, each of said borosilicate glass fibers being cladded with a plurality of microscopic layers of tellurium alternated with polystyrene, each of said borosilicate glass fibers having an entry end and an exiting end, said main optical fiber bundle having a main bundle entry end comprising said entry ends of said borosilicate glass fibers, and said main optical fiber bundle having a main bundle exiting end comprising said exiting ends of said borosilicate glass fibers;
a tapered optical fiber bundle comprising a plurality of tapering optical fibers fixedly attached to one another, each of said tapering optical fibers having a wide entry end and a narrow exiting end, said tapered optical fiber bundle having a tapered bundle wide entry end comprising said wide entry ends of said tapering optical fibers, and said tapered optical fiber bundle having a tapered bundle narrow exiting end comprising said narrow exiting end of said tapering optical fibers, said narrow exiting end of each of said tapering optical fibers being fused to said entry end of one of said borosilicate glass fibers;
a non-imaging optical tube having a non-imaging tube entry end and a non-imaging tube exiting end, said non-imaging tube exiting end being attached to said tapered bundle wide entry end;
a sulfur plasma lamp connected to a parabolic reflector configured to focus light energy emitted from a plasma chamber toward said non-imaging tube entry end; and
a plurality of acrylic rods having a frosted surface, each of said acrylic rods being attached to at least one borosilicate glass fiber's exiting end, each of said acrylic rods being configured to scatter light received by said acrylic rod to said mineshaft so as to illuminate said mineshaft;
wherein said light projected by said sulfur plasma lamp source travels through said non-imaging tube and is, thereby and thereafter essentially evenly distributed on said tapered bundle wide entry end; and
wherein said light travels through said tapering optical fibers, into said main optical fiber bundle, along said borosilicate glass fibers, and into said acrylic rods.
